(19) United States
(12) Patent Application Publication
(10) Pub. No.: US 2017/0341157 A1
(43) Pub. Date: Nov. 30, 2017

(54) TOOL HOLDER FOR A CUTTING TOOL AND SLEEVE FOR A TOOL HOLDER

(71) Applicant: Kennametal Inc., Latrobe, PA (US)

(72) Inventor: JOSEF KONRAD HERUD, HERZOGENAURACH (DE)

(73) Assignee: Kennametal Inc., Latrobe, PA (US)

(21) Appl. No.: 15/674,927

(22) Filed: Aug. 11, 2017

Related U.S. Application Data
(63) Continuation of application No. 13/534,840, filed on Jun. 27, 2012.

(30) Foreign Application Priority Data
Jul. 2, 2011 (DE) 102011106421.8
Oct. 25, 2011 (DE) 102011116831.5

(51) Int. Cl. B23B 31/00; B23B 31/30; B23B 31/02

(52) U.S. Cl. CPC B23B 31/005; B23B 31/028; B23B 31/305; B23B 2250/12; B23B 2231/04; B23B 2231/026; Y10T 279/1249; Y10T 279/3487; Y10T 279/17991; B23B 2260/12; B23B 2260/136; B23B 2231/0256

(57) ABSTRACT

A tool holder for a cutting tool having a tool shank includes a receptacle which extends in an axial direction and a sleeve disposed in the receptacle. The sleeve includes a tool receptacle structured to at least partially receive the tool shank and a blocking element that projects radially into the tool receptacle. The axial positioning of the sleeve is adjustable with respect to the receptacle.

### RELATED APPLICATIONS

This application claims priority to the U.S. patent application associated with Ser. No. 13/534,840 filed Jun. 27, 2012. U.S. patent application Ser. No. 13/534,403 claims priority to German Patent Application No. 102011116831.5 filed Oct. 25, 2011 and German Patent Application No. 102011106421.8 filed Jul. 2, 2011. The contents of each of the foregoing applications are incorporated herein by reference in their entireties.

### BACKGROUND

### Field of the Invention

The invention relates generally to tool holders, and more particularly to chucks for securing cutting tools, such as drilling or milling tools. The invention further relates to sleeves for such tool holders.

### Background Information

In the present context, a cutting tool is understood as being a tool which rotates about its longitudinal axis in operation and has a tool shank in the form of a clamping shank, which is held in a force-fitting manner by clamping fastening, so as to transmit torque, in a tool holder, known as the chuck, which is provided for this purpose. In this case, the clamping shank is usually formed in a cylindrical manner and is clamped in a likewise cylindrical tool receptacle of the tool holder.

Both cutting tools and also corresponding tool holders are known in principle to a person skilled in the art. Frequently, such cutting tools are used for machining hard materials with high precision, and so on the one hand good concentric running properties are desired and on the other it is necessary for large forces or large torques to be transmitted from the tool holder to the cutting tool and ultimately from the cutting tool to the material. Furthermore, in some rotating cutting tools, in particular in milling tools, the problem occurs that, on account of vibrations and the axial pull-out forces that occur during the machining operation, these tools tend to shift axially out of the tool holder.

The international publication WO 2007/118626 A1 discloses a tool holder having a tool receptacle and a clamping shank (accommodated therein) of a tool. The tool holder includes a pull-out prevention means in order to stop the tool from shifting axially. To this end, a plurality of grooves are provided in a distributed manner around the circumference of the tool shank, the grooves extending in particular in a helical manner from the end of the shank. In each case, a blocking element engages into each of the grooves. In some of the exemplary embodiments described therein, a sleeve is fixed in a receptacle of the tool holder.

Axial pull-out prevention by the formation of an undercut in the tool holder for a milling tool is furthermore disclosed in JP 2002/355727 A1. In this embodiment, a transverse bolt is provided as a blocking element directly in the chuck. The milling tool has a specially formed shank having a flattened portion and a transverse groove, such that the milling tool can be plugged in in the axial direction and can form an undercut with the transverse bolt by twisting.

DE 11 2008 000 350 T5 also discloses a similar embodiment, in which axial pull-out prevention of a milling tool is provided.

There is thus room for improvements in tool holders.

### SUMMARY OF THE INVENTION

The present invention improves upon the prior art by providing an improved tool holder as well as an improved sleeve for a tool holder.

The present invention allows for the possibility of adjusting the sleeve axially, such that, on account of the axial adjustment of the sleeve, an axial adjustment of the cutting tool, in particular a milling tool, located in the tool holder, is rendered possible. Axial length setting allows the axial position of the cutting tool to be set quickly and easily, for example in the case of a tool change, without having to change settings on the machine tool. Specifically, the length of the cutting tools used can vary on account of wear and regrinding operations.

The blocking element may be fixed permanently in its position in relation to the tool holder, i.e. in particular connected captively. In particular, no adjusting mechanism whatsoever is provided for the blocking element, as a result of which the configuration of the axial securing means can be maintained particularly easily.

In an expedient refinement, the sleeve is formed in this case in an approximately pot-like manner with a sleeve base. The sleeve base serves in this case in particular for at least indirectly supporting the tool shank within the sleeve. In an expedient development, it is provided that a spring element is arranged at the base of the sleeve, the spring element being supported in particular on the sleeve base. A restoring force is exerted on the tool shank via the spring element. As a result, it is for example possible to compensate for production-induced but undesired play between the blocking element and the transverse groove in the blocking position. In addition, the cutting tool is brought into a defined position prior to clamping by the chuck.

For axial adjustment, the sleeve expediently has a thread which interacts with a corresponding threaded portion of the receptacle. As a result, the axial position can easily be set precisely. To this end, it is expediently provided that the sleeve has at its base a threaded bolt which projects in the axial direction. The threaded bolt is provided at the base in a corresponding threaded portion of the receptacle. As a result of this embodiment having the thread, in addition to the possibility of axial adjustment, exchangeability of the sleeve is enabled at the same time.

In an alternative refinement to the threaded bolt, the sleeve may itself be provided with the thread on its lateral surface. As a result of this measure, in spite of the possibility of axial adjustment, a very short physical length of the sleeve having the thread is achieved. In contrast with the embodiment having the threaded bolt, the overall length can be virtually halved. As a result, a shorter physical length of the chuck is enabled as a whole. Experiments have shown that a physical length of the entire chuck which is as short as possible, in particular in the case of hydraulic chucks, has a positive effect on operation which has as little vibration as possible.

With regard to adjustment of the sleeve which is as easy as possible, the sleeve has a tool engagement portion for an adjusting tool. This is for example a simple slot, or an external or internal polygonal engagement portion in which in each case the adjusting tool engages for adjustment. In an advantageous embodiment, the tool engagement portion is formed by an external engagement portion on a sleeve collar that extends beyond the receptacle. Actuation can take place in a simple manner with the aid of an open-end wrench on the front end of the chuck. Alternatively, the tool engagement portion may be formed on the end side of the threaded bolt. In such embodiment, actuation takes place by the introduction of the adjusting tool into the tool holder from the rear side.

At least one transverse bolt is provided as a blocking element, that is to say a bolt that extends both transversely to the axial direction and transversely to a radial direction. The appropriately designed tool shank of the cutting tool engages behind the bolt. To this end, it is generally provided that the tool shank has a flattened portion and also an at least regionally circumferential transverse groove. The embodiment with a transverse bolt as a blocking element is very easy and cost-effective to manufacture. At the same time, good pull-out prevention is ensured.

Expediently, the blocking element is generally limited to the extent of the sleeve, that is to say the blocking element does not penetrate into the wall of the receptacle. Overall, the sleeve creates a self-contained, separate component, by way of which pull-out prevention is ensured. The actual securing of the sleeve in the receptacle preferably takes place via the thread.

With regard to a configuration which is as simple as possible, the blocking element itself is also in the form of a separate part, in particular a bolt, which is introduced transversely into the sleeve. To this end, the latter has a through-passage opening, at least on one side, through which the blocking element is insertable.

According to a further advantageous embodiment, the sleeve may be in the form of a reducing sleeve. It is particularly advantageous in this case that the tool shank is clamped along its entire length in the reducing sleeve and is not displaced within the reducing sleeve. As a result, the clamping force and thus the transmission of torque remains high, this being of considerable importance for a machining result that remains continuously good in the case of machining operations that are subjected to high loads, in particular milling operations. Since the blocking element is part of the reducing sleeve, this axial securing mechanism is suitable in particular also as a retrofit set for all machine tools having a tool holder, which is also provided for the use of reducing sleeves.

In this case, the reducing sleeve extends generally along the entire axial length of the receptacle and as a result reduces the cross section thereof overall. Reducing sleeves are used generally as exchangeable elements in order to be able to reliably clamp tools having different diameters with one and the same tool holder.

As an alternative to the embodiment as a reducing sleeve, in which the tool shank is clamped, the sleeve itself has no clamping function but serves merely for axial pull-out prevention. To this end, the sleeve receives preferably only the rear part of the tool shank without clamping the latter in. In this variant embodiment, it is accordingly may also be provided that the receptacle is subdivided into a front clamping region, in which the tool shank is clamped, and a rear adjusting region, in which the sleeve is arranged in an adjustable manner. The rear adjusting region therefore also has a larger diameter compared with the clamping region. The axial length of the adjusting region is in this case greater than the axial extent of the sleeve, in order to allow the latter to be adjusted within the adjusting region. The actual clamping region of the receptacle is preferably formed directly by the tool holder without further sleeves.

Furthermore, a tool holder configured in the manner of a hydraulic expansion chuck is provided. Such a hydraulic expansion chuck is known in principle to a person skilled in the art and described for example in the laid-open publication WO 2005/097383 attributed to the applicant. Machine tools having such tool holders are distinguished inter alia by good concentric running properties and are therefore particularly suitable when low manufacturing tolerances are required.

In this case, the hydraulic expansion chuck has typically a hydraulic chamber that is bounded by an internal wall. In this connection, it is advantageous for the blocking element to not penetrate through the internal wall of the hydraulic chamber. A spatial separation between the blocking element and the hydraulic chamber is thus formed.

In particular the combination of the (reducing) sleeve with the hydraulic expansion chuck allows the reliable use of an end milling cutter with the expansion chuck. On account of the axial pull-out prevention, the end milling cutter is held securely in the chuck in spite of the forces that occur in the axial direction. At the same time, a sufficiently high clamping force for the necessary torque take-over, which takes place of course only via the force-fit on account of the clamping of the tool shank in the chuck is ensured. This is because, since axial securing is exclusively on the inside, i.e. does not affect the function of the expansion chuck, the hydraulically activated clamping region can extend along a very long axial length.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

A full understanding of the invention can be gained from the following description of the preferred embodiments when read in conjunction with the partially schematic figures in which:

FIG. 1.1 shows a front view of a cutting tool in an example embodiment having a flattened portion and a transverse groove in the form of a partial annular groove,

FIG. 1.2 shows the cutting tool partly in a side view and partly in a sectional illustration,

FIG. 1.3 shows a side view of a detail of the tool shank of the cutting tool,

FIG. 2.1 shows a front view of an alternative cutting tool having two flattened portions and a circumferential annular groove,

FIG. 2.2 shows the alternative cutting tool partly in a side view and partly in a sectional illustration,

FIG. 2.3 shows a side view of a detail of the tool shank of the alternative cutting tool,

FIG. 3.1 shows a sectional illustration of a first variant embodiment of a tool holder, together with a reducing sleeve according to a first embodiment and a clamped-in cutting tool,

FIG. 3.2 shows a perspective view of the tool holder together with the clamped-in reducing sleeve and a cutting tool which is clamped therein and is illustrated in a greatly simplified manner,

FIG. 4.1 shows a front view of the reducing sleeve in an example embodiment of the cutting tool according to FIGS. 1.1 to 1.3,

FIG. 4.2 shows a perspective view of the reducing sleeve,

FIG. 4.3 shows a side view of the reducing sleeve,

FIG. 4.4 shows a side view of the reducing sleeve with schematically indicated internal workings,

FIG. 4.5 shows the sectional illustration A-A according to FIG. 4.1,

FIG. 4.6 shows the sectional illustration B-B according to FIG. 4.3,

FIG. 4.7 shows a bottom view of the reducing sleeve,

FIG. 4.8 shows the sectional illustration C-C according to FIG. 4.7,

FIG. 5.1 shows a front view of an alternative reducing sleeve,

FIG. 5.2 shows a perspective view of the alternative embodiment of the reducing sleeve,

FIG. 5.3 shows a side view of the alternative reducing sleeve,

FIG. 5.4 shows a side view of the alternative reducing sleeve with schematically indicated internal workings,

FIG. 5.5 shows the sectional illustration D-D according to FIG. 5.1,

FIG. 5.6 shows the sectional illustration E-E according to FIG. 5.3,

FIG. 5.7 shows a bottom view of the alternative reducing sleeve,

FIG. 5.8 shows the sectional illustration F-F according to FIG. 5.7.

FIG. 6.1 shows a sectional illustration of a second variant embodiment of a tool holder together with a sleeve and a cutting tool which is clamped therein and is illustrated in a greatly simplified manner,

FIG. 6.2 shows a perspective view of the tool holder according to FIG. 6.1,

FIG. 7.1 shows a perspective view of the sleeve illustrated in FIG. 6.1,

FIG. 7.2 shows a longitudinal section through the sleeve according to FIG. 7.1,

FIG. 7.3 shows a cross section through the sleeve according to FIG. 7.2,

FIG. 8.1 shows a perspective view of an alternative embodiment of a sleeve,

FIG. 8.2 shows a first longitudinal-section view of the sleeve according to FIG. 8.1,

FIG. 8.3 shows a second longitudinal-section view of the sleeve along the section line J-J in FIG. 8.4,

FIG. 8.4 shows a plan view of the rear side of the sleeve according to FIG. 8.1,

FIG. 8.5 shows a section view along the section line L-L according to FIG. 8.6, and

FIG. 8.6 shows a side view of the sleeve according to FIG. 8.1.

### DETAILED DESCRIPTION

Directional phrases used herein, such as, for example, left, right, front, back, top, bottom and derivatives thereof, relate to the orientation of the elements shown in the drawings and are not limiting upon the claims unless expressly recited therein. Identical parts are provided with the same reference number in all drawings.

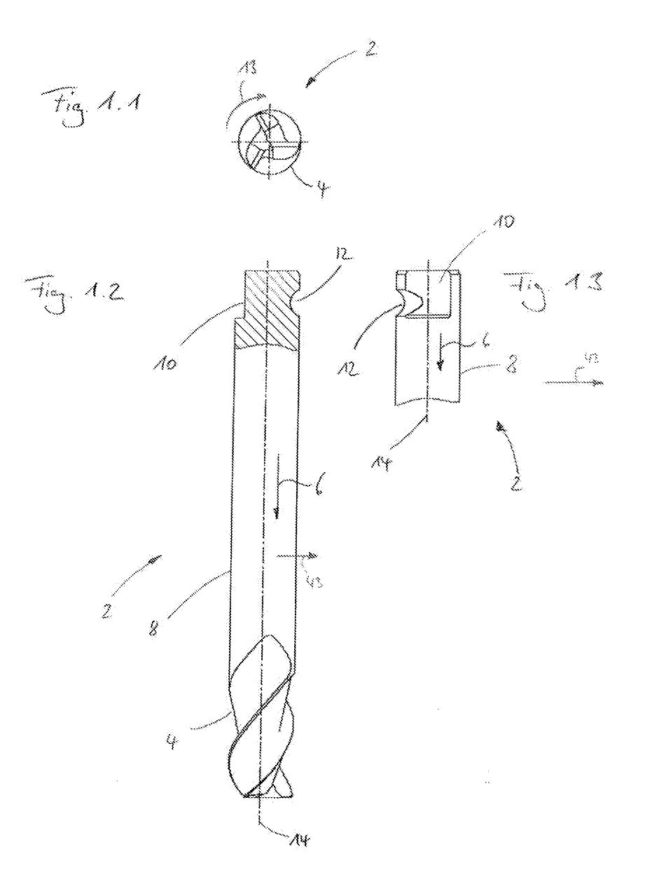

In the exemplary embodiment described in the following text, a cutting tool 2 has a cutting part 4 and a tool shank 8 that adjoins the latter counter to an axial direction 6. Worked into the tool shank 8 are, as illustrated in FIG. 1.2 and FIG. 1.3, a flattened portion 10 and a transverse groove that directly adjoins the latter and is in the form of a partial annular groove 12.

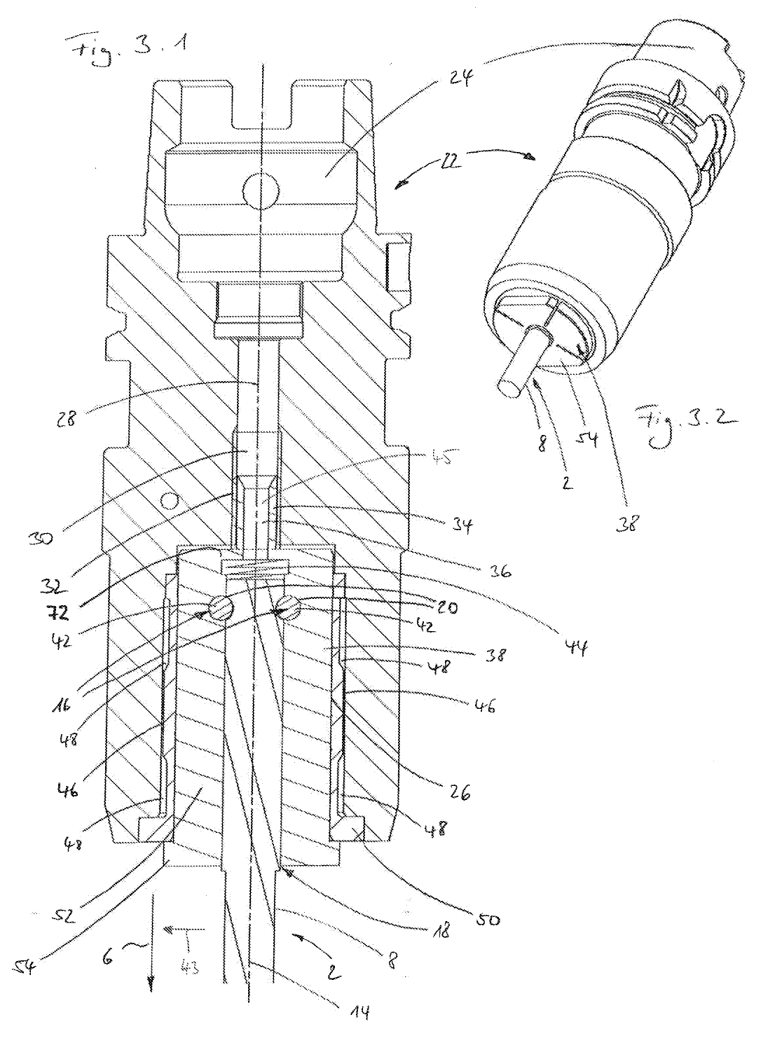

On account of the flattened portion 10, the shank cross-sectional area of a free end of the cylindrical tool shank 8 is reduced, with an abrupt or step-like transition, as seen in the axial direction 6, being provided in this regard. The surface formed in this way of the tool shank 8 in the region of the flattened portion 10 is substantially planar and cuboidal. In particular values in the order of magnitude of half the diameter of the tool shank 8 are provided for the extent of that cuboidal surface both in the axial direction 6 and also perpendicularly thereto. The partial annular groove 12 that extends perpendicularly to the axial direction 6 is formed as a groove having an arcuate cross section, and in particular a cross section in the form of a segment of a circle, and extends in the circumferential direction 13 over an angular region of about 180°. In this case, the radial distance of the partial annular groove 12 from a central longitudinal axis 14 of the cutting tool 2 is constant over the entire extent in the circumferential direction 13. Furthermore, the partial annular groove 12 is arranged in the region of the periphery, facing the cutting part 4, of the cuboidal surface of the flattened portion 10. One end of the partial annular groove 12 leads into the flattened portion 10, while the opposite end forms, in a manner which is not illustrated in more detail, a stop that acts in the circumferential direction 13. The depth of the partial annular groove 12 and the form of the reduction of the shank cross-sectional area in the region of the flattened portion 10 are of comparable orders of magnitude and adapted to that extent to which a blocking element 16 projects radially into a tool receptacle 18 for the cutting tool 2 (cf., for example, FIG. 3.1).

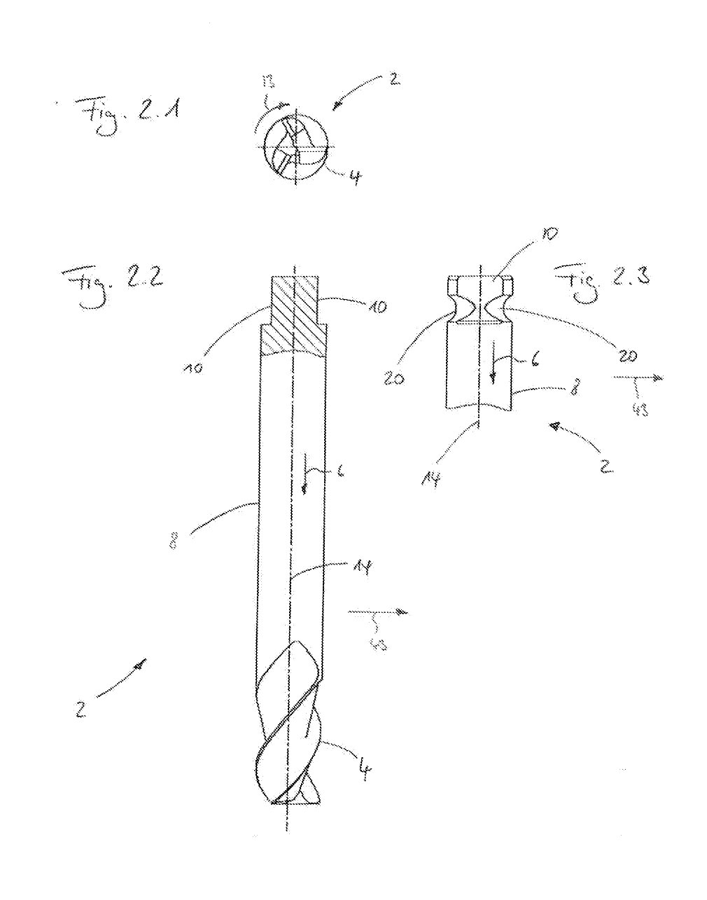

An alternative form of the tool shank 8 of the cutting tool 2 is shown in illustrations in FIG. 2.1 to FIG. 2.3. Here, the cutting tool 2 has, at the end of the tool shank 8, two substantially identical flattened portions 10 of the above-described type and form, the flattened portions 10 being positioned circumferentially and opposite one another at the free end of the cylindrical tool shank 8. At the axial level of the partial annular groove 12 of the previous exemplary embodiment, there is provided in this cutting tool 2 a circumferential complete annular groove 20, the cross section of which is in turn arcuate or in the form of a segment of a circle. In this variant embodiment, too, the extent of each flattened portion 10 and also the depth of the complete annular groove 20 is adapted to the form and position of the blocking element 16 of the tool receptacle 18.

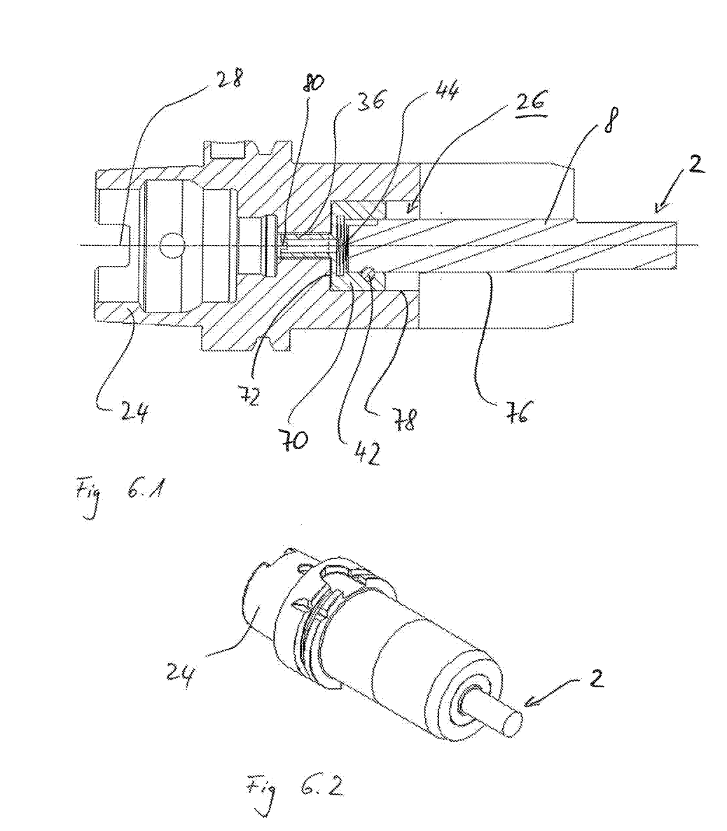

An axial securing mechanism comprises, in addition to a partial annular groove 12 or a complete annular groove 20, also a securing or blocking element 16. The latter projects into the tool receptacle 18 for the tool shank 8 and, in the operating state of a machine tool, forms together with the partial annular groove 12 or the complete annular groove 20 a form-fitting connection, by way of which the cutting tool 2 is secured against shifting out of the tool receptacle 18. A corresponding operating state is illustrated by way of example in FIG. 3.1 and FIG. 3.2 and also in FIGS. 6.1 and 6.2. In this case, a hydraulic expansion chuck 22 is connected in a manner which is not illustrated in more detail to a machine tool via a hollow shank taper-machine spindle interface (HSK for short) 24. For the benefit of compatibility which is as good as possible, as an alternative, further interfaces, in particular standardized interfaces such as an interface having a steep taper shank (SK for short) or having a Kennametal receptacle (KM for short), for example, are provided.

The structure of the illustrated hydraulic expansion chuck 22 is similar to an embodiment which is described in detail in the laid-open specification WO 2005/097383. Therefore, express reference is made to the entire disclosure of this document attributed to the applicant.

The chuck 22 has a receptacle 26. This can be described to a close approximation as cylindrical and thus rotationally symmetrical to a central longitudinal axis 28 of the hydraulic expansion chuck 22. At its base, the receptacle 26 is continued by a duct 30 having a circular cross section and an internal thread 32. The duct 30 serves, inter alia, as a supply line for a coolant and/or lubricant. An external thread 34 of a threaded bolt 36 engages in the internal thread 32, said threaded bolt 36 being for its part integrally formed on the base side of a reducing sleeve 38. In the operating state illustrated, the threaded bolt 36 is screwed into the duct 30, and so the reducing sleeve 38 is fixed in the receptacle 26 and is additionally adjusted with respect to the axial relative position in relation to the hydraulic expansion chuck 22.

Worked centrally into the reducing sleeve 38 is the cylindrical tool receptacle 18 (clamping receptacle), in which the cutting tool 2 is clamped by way of its tool shank 8 in the operating state. In this case, two opposite transverse bolts 42, which act here as blocking element 16, by way of example, and are positioned transversely to the axial direction 6 and also transversely to a radial direction 43, engage in the complete annular groove 20 on the cutting tool 2. As a result, a form-fitting connection is formed between the reducing sleeve 38 and the cutting tool 2, the form-fitting connection blocking the axial movements of the cutting tool 2. Furthermore, at the base of the reducing sleeve 38 there is arranged a cylindrical compression spring 44, the restoring force of which is directed in the axial direction 6 and acts on the end face of the tool shank 8. Accordingly, the compression spring 44 pushes the tool shank 8 in the axial direction 6, and so any production-induced play present between each transverse bolt 42 and the complete annular groove 20 is compensated. In an example embodiment, the transverse bolts 42 are positioned such that the axial distance between the transverse bolts 42 and the base of the reducing sleeve 38 corresponds to about half the diameter of the reducing sleeve 38. Furthermore, the tool receptacle 18 is connected in a fluid-conducting manner to the duct 30. A supply duct 45 which is provided therefor, passes centrally through the threaded bolt 36 and through the base of the reducing sleeve 38, such that the cooling oil and/or lubricating oil can be introduced via said supply duct 45 into a supply opening worked at the end side into the free end of the cutting tool 2.

In order to clamp the reducing sleeve 38 and the cutting tool 2 in the hydraulic expansion chuck 22, the volume of a hydraulic reservoir is reduced by means of a grub screw in a manner which is not illustrated. The hydraulic oil located in the reservoir is then pressed via connecting ducts 46 into hydraulic chambers 48, as a result of which a membrane-like expanding bush 50 expands or rather deforms in the direction of the central longitudinal axis 28. Consequently, a press connection is formed both between the receptacle 26 and the reducing sleeve 38 and between the reducing sleeve 38 and the cutting tool 2.

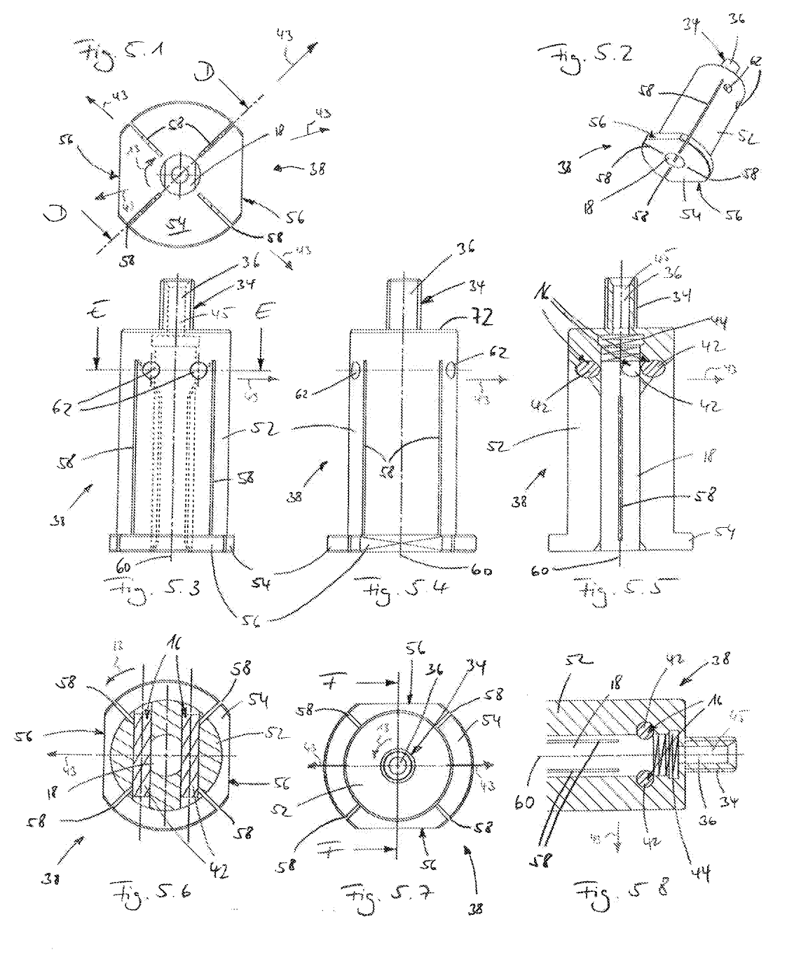

A more detailed illustration of the reducing sleeve 38 is given in the illustrations in FIG. 5.1 to FIG. 5.8. In addition to a cylindrical basic body 52, into which the tool receptacle 18 is worked, and the threaded bolt 36 integrally formed on the base side, the reducing sleeve 38 has at its end a disc-like reducing sleeve collar 54, which is integrally formed opposite the threaded bolt 36 on the basic body 52. As can be seen from FIG. 5.1, the reducing sleeve collar 54 is radially flattened, such that wrench flats 56 are produced on the disc circumference. These wrench flats 56 form a tool engagement portion for screwing in the reducing sleeve 38 (axial adjustment). The orientation of the wrench flats 56 reflects in a supplementary manner the substantially parallel arrangement of the longitudinal axes of the two transverse bolts 42 and thus serves as an assembly aid when the cutting tool 2 is inserted, wherein, in order to introduce the tool shank 8 into the tool receptacle 18, the flattened portion 10 has to be aligned approximately plane-parallel to the wrench flats 56. In precisely this orientation, the flattened portion 10 and the transverse bolts 42 are oriented in relation to one another such that axial displacement of the cutting tool 2 in the tool receptacle 18 is possible.

The basic body 52 of the reducing sleeve 38 has four longitudinal slots 58, which are worked in circumferentially in an equally distributed manner and by way of which, when pressure is exerted on the circumference, a reversible yielding of the basic body 52 in the direction of a central longitudinal axis 60 of the reducing sleeve 38 is promoted. These longitudinal slots 58 extend in this case approximately parallel to the central longitudinal axis 60 and extend along approximately 80% of the extent of the basic body 52 in the axial direction 6. In addition, the longitudinal slots 58 are continued in the sleeve collar 54, this continuation not being configured completely in the region of the introduction opening for the cutting tool 2 into the tool receptacle 18.

For the benefit of simple production of the reducing sleeve 38, two press-in ducts 62 are worked into the basic body 52, into which press-in ducts 62 the transverse bolts 42 are pressed as part of an assembly step, and in the process are positioned fixedly in the intended end position. The transverse bolts 42 also act, as illustrated in FIG. 5.8, as a stop for the cylindrical compression spring 44, such that the latter is secured against falling out.

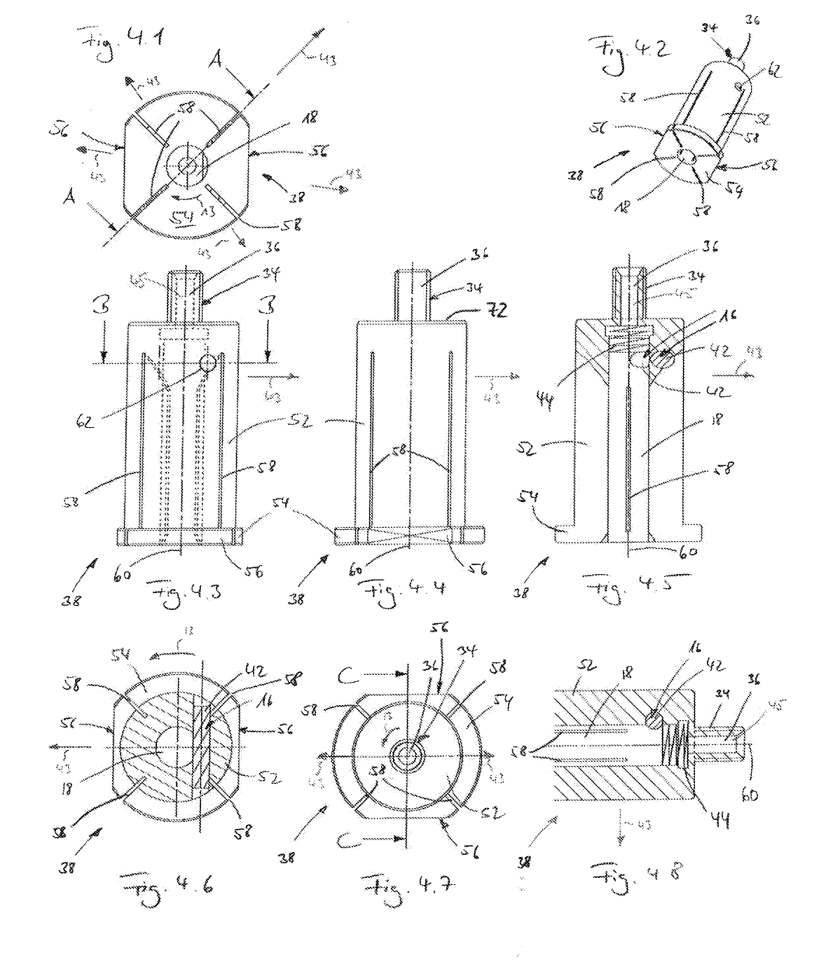

An alternative example design of the reducing sleeve 38 is shown in the illustrations in FIG. 4.1 to FIG. 4.8. This design differs in that only one transverse bolt 42 is provided as blocking element 16. This design has the advantage of particularly simple production of the tool shank. The transverse groove is in this case in the form of a partial annular groove 12, such that a stop is formed and defined and easy insertion of the cutting tool is allowed. Generally, the flattened portion(s) and the transverse groove are worked in all exemplary embodiments into the originally cylindrical shank preferably by simple grinding methods.

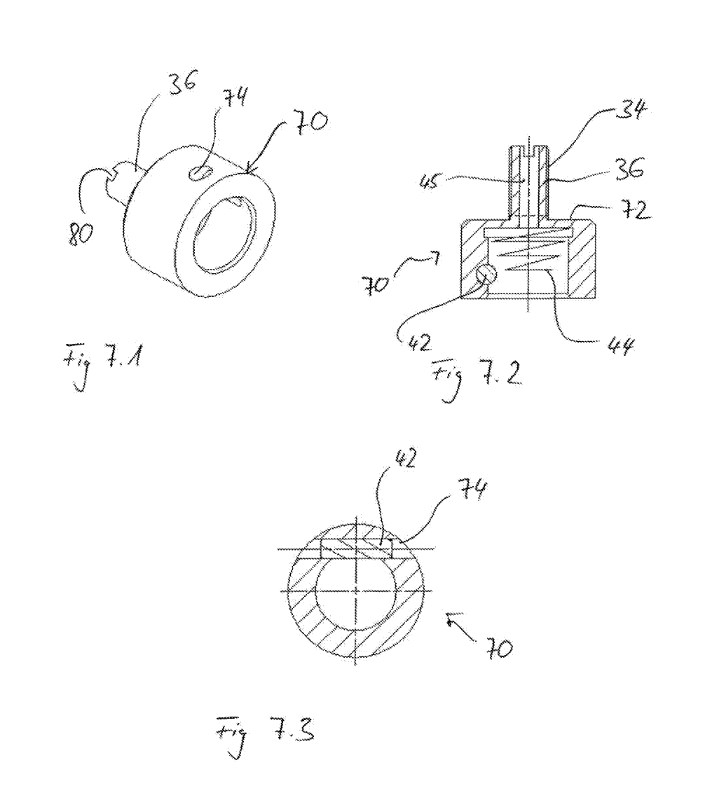

FIG. 6 and FIG. 7 illustrate a second variant embodiment of the tool holder having a sleeve 70 which serves merely for axial pull-out prevention and has no clamping function. The basic structure of the sleeve 70 with the transverse bolt 42 as blocking element, the threaded bolt 36 for screwing into the receptacle 26 and the compression spring 44 arranged in the interior of the sleeve 70 is identical or at least largely identical to the configuration of the pull-out prevention means in the case of the reducing sleeve 38 as is illustrated for example in FIG. 4.2. In FIGS. 6.1 and 7.2, the pot-like configuration of the sleeve 70 having the sleeve base 72, on which the compression spring 44 is supported, can be seen very clearly.

As can be gathered in particular from FIGS. 7.1 and 7.3, the sleeve 70 (just like the reducing sleeve 38) has in its outer wall an aperture 74 formed in the manner of a through-passage hole, such that the transverse bolt 42 can be pushed easily into the aperture 74. This makes simple production possible. As can be seen in particular from FIG. 7.3, the transverse bolt 42 does not project at least beyond the outer wall of the sleeve 70.

The tool holder according to FIG. 6.1 is illustrated in a partial sectional view, in which only the rear part of the tool holder is illustrated in a sectional view. In this variant embodiment, the receptacle 26 is subdivided into a front clamping region 76 which is formed in FIG. 6.1 by the nonhatched subregion. In the rear part, the receptacle 26 forms an adjusting region 78, in which the sleeve 70 is arranged in a longitudinally adjustable manner. The clamping region 76 is formed preferably directly by the chuck without the use of an additional sleeve such as a reducing sleeve or the like, for example. In particular, the clamping region is formed directly by an expansion chuck, the tool shank 8 being formed preferably directly by a corresponding inner wall, bounding a hydraulic chamber, of the chuck.

The insertion of the tool shank 8 and the axial pull-out prevention thereof by the formation of the undercut by way of the transverse bolt 42 take place in the same way as for the reducing sleeve, as is described in FIG. 4.2. In principle, the axial pull-out prevention of the sleeve 70 can also take place with two transverse bolts 42, as in the case of the reducing sleeve according to FIG. 5.2.

The axial adjustment of the sleeve 70 takes place with the aid of a tool engagement portion, which, in the case of the exemplary embodiment of the sleeve 70, is in the form of a transverse slot 80 on the rear end side of the threaded bolt 36.

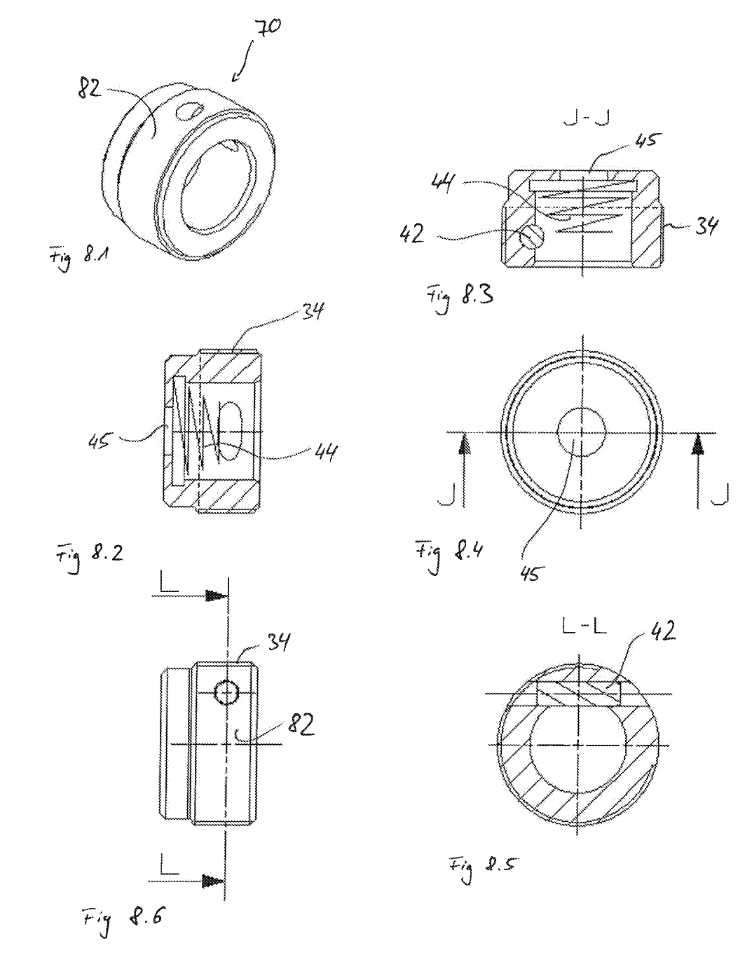

FIGS. 8.1-8.6 illustrate a preferred alternative of the sleeve 70. As can be gathered in particular from the sectional illustrations in FIG. 8.2 and FIG. 8.3, the sleeve has the external thread 34 on its outer casing 82. In comparison with the exemplary embodiment described with regard to FIGS. 7.1-7.3, this sleeve therefore differs by the elimination of the threaded bolt 36, instead of which the outer casing 82 is provided with the thread 34. The rest of the embodiment, in particular the arrangement of the transverse bolt 42 and of the compression spring 44, is identical to the exemplary embodiment according to FIGS. 7.1-7.3. In a manner corresponding to the alternative embodiment of the sleeve 70, the receptacle 26 is also formed with an associated internal thread on the lateral surface of the receptacle 26. The internal thread begins preferably at the front end side and extends in particular along at least virtually the entire length of the receptacle 26 in the direction of the interface 24. In comparison with the variant embodiment illustrated in FIG. 6.1, the intermediate portion, in which the threaded bolt 36 is enclosed, has been dispensed with. The entire tool holder 22 is therefore shortened by this intermediate portion, compared with the exemplary embodiment in FIG. 6.1.

In contrast to the exemplary embodiment in FIGS. 7.1-7.3, the sleeve 70 also has, on account of the formation of the thread 34 on the outer casing 82, a larger diameter in the front region of the thread 34 than in a rear region. In the exemplary embodiment, the thread 34 extends from the end side along about two thirds of the length of the sleeve 70.

The longitudinal adjustment of the sleeve takes place—as in the previous exemplary embodiments—by twisting the sleeve. On account of the form-fitting and rotationally locked fastening of the tool 2 via the transverse bolt 42, this can also take place, with a tool 2 inserted, by for example a manual rotary movement of the tool 2 in the not yet clamped state. Alternatively, in order to longitudinally adjust the sleeve 70 a tool engagement portion 80 is formed preferably—in a manner not illustrated in more detail here—on the rear side within the receptacle 26 of the chuck 22, such that the desired longitudinal adjustment takes place via a rotary movement of the sleeve 70. To this end, in an expedient embodiment, the rear through-passage opening, which is in the form of the supply duct 45, is in the form of a polygonal receptacle, for example a hexagonal receptacle, on which a correspondingly formed polygon wrench can act.

While specific example embodiments of the invention have been described in detail, it will be appreciated by those skilled in the art that various modifications and alternatives to the details provided herein could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

1. A tool holder for a cutting tool having a tool shank, the tool holder comprising:
a receptacle which extends in an axial direction;
a sleeve disposed in the receptacle, the sleeve having:
a tool receptacle structured to at least partially receive the tool shank; and
a base having a bolt extending outward therefrom in the axial direction,
wherein the axial positioning of the sleeve is adjustable with respect to the receptacle.

2. The tool holder of claim 1 wherein the sleeve is formed in a pot-like manner and includes a sleeve base.

3. The tool holder of claim 1 wherein the sleeve comprises a spring element arranged at a base of the sleeve and wherein the spring element is structured to exert a restoring force on the tool shank when the cutting tool is inserted in the sleeve.

4. The tool holder of claim 1 wherein the sleeve comprises a thread structured to provide for adjustment of the axial positioning of the sleeve with respect to the receptacle.

5. The tool holder of claim 4 wherein the bolt has an externally threaded surface.

6. The tool holder of claim 4 wherein the sleeve includes an outer casing in which the thread is provided.

7. The tool holder of claim 1 wherein the sleeve comprises a portion structured to be engaged by an adjusting tool for adjusting the axial position of the sleeve with respect to the receptacle.

8. The tool holder of claim 1 wherein the sleeve is in the form of a reducing sleeve and is structured to receive the tool shank in a clamping manner.

9. The tool holder of claim 1 wherein the receptacle is subdivided into a front clamping region structured to receive the tool shank in a clamping manner, and a rear adjusting region in which the sleeve is arranged in an adjustable manner with respect to the receptacle.

10. The tool holder of claim 1 wherein the tool holder is configured in the manner of a hydraulic expansion chuck.

11. A sleeve for inserting in a receptacle in a tool holder, the sleeve comprising:
a tool receptacle structured to receive at least a portion of a shank of a cutting tool;
an adjusting mechanism structured to provide for adjustment of the axial positioning of the sleeve within the receptacle,
wherein the adjusting mechanism comprises a threaded bolt structured to engage a threaded portion of the tool holder.
